(19) United States
(12) Patent Application Publication
(10) Pub. No.: US 2013/0165192 A1
(43) Pub. Date: Jun. 27, 2013

(54) Dual Outlet Fan in Axial Flow Combine

(71) Applicants: James M. Kopriva, Culbertson, NE (US); Robert A. Matousek, Milan, IL (US); Bryan S. Claerhout, Hesston, KS (US)

(72) Inventors: James M. Kopriva, Culbertson, NE (US); Robert A. Matousek, Milan, IL (US); Bryan S. Claerhout, Hesston, KS (US)

(73) Assignee: AGCO Corporation, Duluth, GA (US)

(21) Appl. No.: 13/337,345

(22) Filed: Dec. 27, 2011

(51) Int. Cl. A01F 12/48

(52) U.S. Cl. 460/100

(57) ABSTRACT

A combine harvester has a threshing mechanism with a rotor and a plurality of concaves for threshing grain and cleaning apparatus for removing chaff from the threshed grain. The cleaning apparatus includes a rotor pan arranged below the concaves and a sieve arranged below the rotor pan. A fan is arranged to blow air into an inlet. A duct has a wall defining a passage in fluid communication with the inlet, a first exhaust and a second exhaust in fluid communication with the passage. The first exhaust is arranged to direct a first portion of airflow on the sieve and then up toward the underside of the rotor pan. The second exhaust is located above the rotor pan and arranged to direct a second portion of airflow between the top of the rotor pan and an underside of the concaves.

### CROSS-REFERENCE TO RELATED APPLICATIONS

The current application is related to U.S. patent application Ser. No. 13/326,312 filed on Dec. 14, 2011, entitled “Cascade Pan,” and having Attorney Docket No. A0831 H, which is hereby incorporated by reference in its entirety.

### BACKGROUND

Equipment such as, for example, agricultural machines, may have a fan. The fan may be used to create airflow. The airflow may be used for various purposes such as, for example, cleaning and cooling equipment parts.

### BRIEF DESCRIPTION OF THE DRAWINGS

The accompanying drawings, which are incorporated in and constitute a part of this disclosure, illustrate various embodiments of the disclosure. In the drawings:

FIG. 1 is a diagram of a combine;

FIG. 2 is a diagram of a dual outlet fan; and

FIG. 3 is a flowchart showing a method for separating grain from material other than grain.

### DETAILED DESCRIPTION

### Overview

A dual outlet fan may be disclosed. The dual outlet fan may comprise a rotor pan, a sieve, a fan, and a duct having a wall. The rotor pan may be arranged below a rotor and may have an underside. The sieve may be arranged below the rotor pan. The fan may be arranged to blow air into an inlet. The wall may define a passage in fluid communication with the inlet, a first exhaust and a second exhaust. The first exhaust may be arranged to direct a first portion of airflow toward the underside of the sieve. The second exhaust may be arranged to direct a second portion of airflow substantially parallel to the rotor pan.

Both the foregoing general description and the following detailed description are examples and explanatory only, and should not be considered to restrict the disclosure's scope, as described and claimed. Further, features and/or variations may be provided in addition to those set forth herein. For example, embodiments of the disclosure may be directed to various feature combinations and sub-combinations described in the detailed description.

### Example Embodiments

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

Fans may be used within agricultural equipment to facilitate separating grain from material other than grain (MOG). Fans may be connected to a duct. The fan may produce an airstream. The airstream may be used to stratify the grain and the MOG. Once stratified, the grain may be sent to a storage bin and the MOG may be discarded.

While this disclosure describes cascade pans in the context of a combine, embodiments are not limited to an agricultural working environment. In other words, applications where a cascade pan may be desirable include not only agricultural equipment, but also include, for example, industrial, mining, and manufacturing applications.

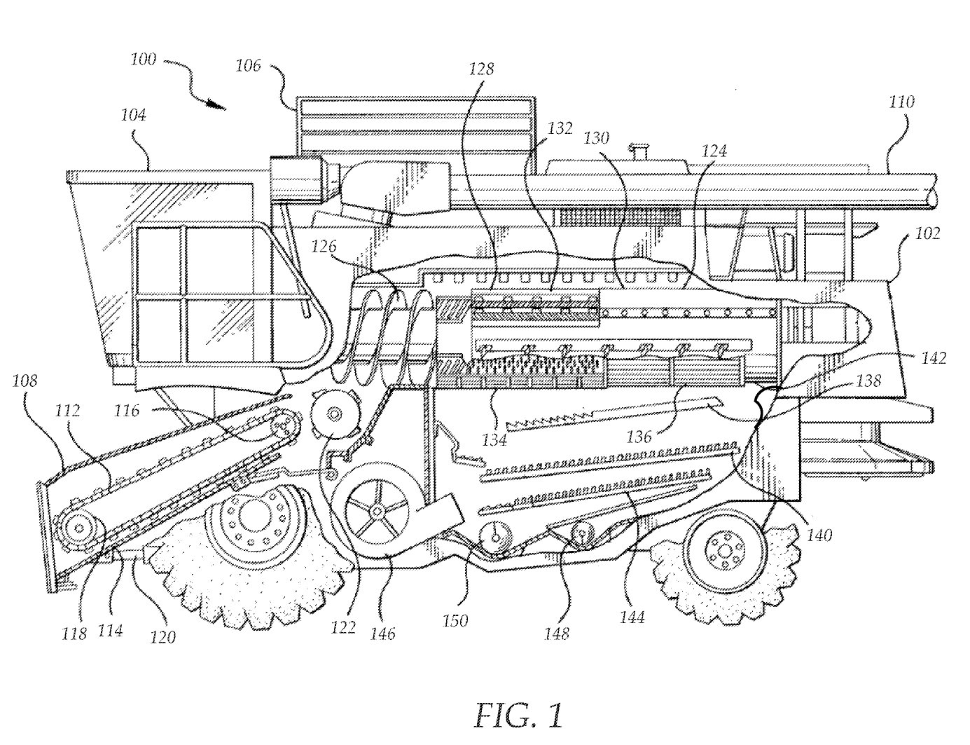

FIG. 1 is a diagram of a combine 100. Combine 100 may comprise a separator housing 102, an operator's work station and cab 104, a grain tank 106, and an elevator assembly 108. A swingable unloading auger assembly 110 may pivot to a position extending laterally outward to one side of combine 100 to unload grain tank 106. Unloading auger assembly 110 may swing inward to a storage position as shown in FIG. 1 when grain tank 106 is not being unloaded.

Elevator assembly 108 may have a conveyor 112 mounted in an elevator housing 114. Conveyor 112 may be trained around rear drive sprockets 116 and a front drum 118. Hydraulic linear actuators 120 may pivot elevator housing 114 to raise and lower the forward end of elevator housing 114.

Crop material may be fed to a feed beater 122 by conveyor 112 in elevator housing 114. Feed beater 122 may feed crop material to a separating rotor 124. Separating rotor 124 may comprise a feed section 126, a threshing section 128, and a separation section 130. Feed section 126 may move crop material in a spiral path about a generally horizontal fore and aft axis of rotation to separating rotor 124, toward threshing section 128. In threshing section 128, crop material may pass between a cylinder bar 132 and a concave 134 where grain may be threshed. Threshed grain, that is not separated by concave 134, may be separated in separation section 130 and may pass through a separation grate 136. A rotor pan 138 may convey grain and chaff forward and may deposit it on a chaffer 140. Before reaching chaffer 140, the grain, chaff, and MOG may pass a cascade pan. MOG may be discharged from separating rotor 124 through a rotor discharge 142.

Grain and MOG that may pass through concave 134 and separation grate 136 may fall to rotor pan 138. Rotor pan 138 may convey grain and chaff forward and may deposit it on chaffer 140. The grain may be cleaned by chaffer 140 and a sieve 144 and air from a fan assembly 146. Clean grain may fall into a clean grain auger 148. The clean grain may be conveyed to grain tank 106 by clean grain auger 150 and an elevator (not shown). Tailings may fall into a returns auger 150 and may be conveyed to separating rotor 124 by returns auger and return elevators (not shown), where they may be threshed a second time.

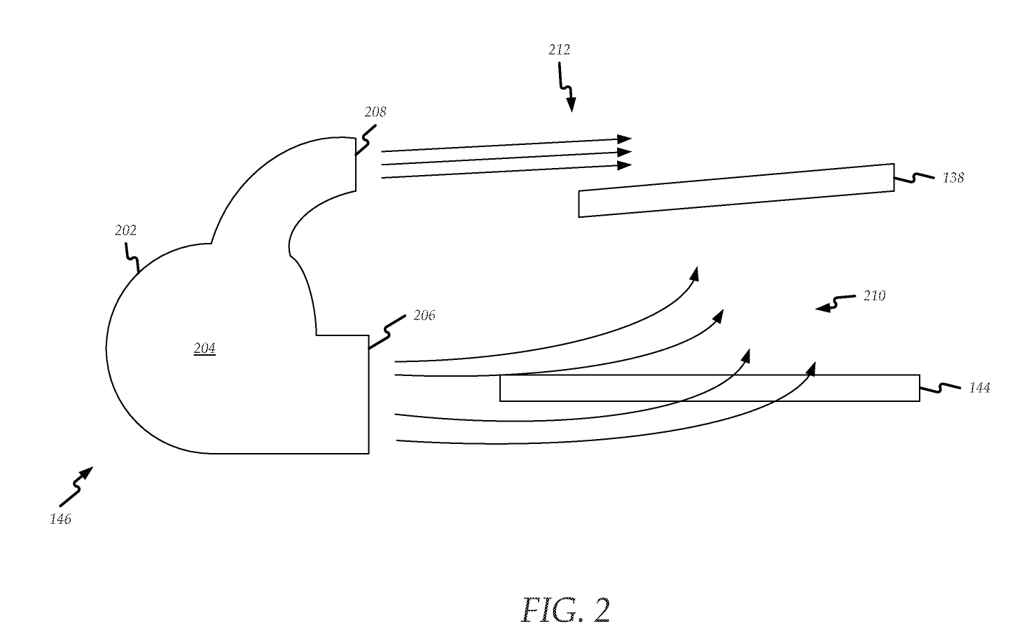

FIG. 2 is a schematic of rotor pan 138's, sieve 144's, and fan assembly 146's orientation to on another. Note that while FIGS. 1 and 2 show only one sieve, embodiments may comprise two or more sieves. Fan assembly 146 may comprise a wall 202. Wall 202 may define a passage 204, a first exhaust 206, and a second exhaust 208. First exhaust 206 may be arranged below rotor pan 138. First exhaust 206 also may be arranged to direct a first portion of airflow toward rotor pan 138, both above and below rotor pan 138 as indicated by first arrows 210. First exhaust 206 may be arranged at a first elevation and second exhaust 208 may be arranged at a second elevation. The first elevation may be lower than the second elevation.

The first portion of airflow may be at an angle perpendicular to rotor pan 138. In addition, the first portion of airflow may be at an angle to assist in discharging MOG from combine 100. Second exhaust 206 also may be arranged to direct a second portion of airflow toward the rear of combine 100, as indicated by second arrows 212.

During operation, a fan may be located inside passage 204. The fan may blow air into first exhaust 206 and second exhaust 208. The amount of air blown into first exhaust 206 and second exhaust 208 (i.e., the first portion of airflow and the second portion of airflow) may be equal or different. In other words, the first portion of airflow and the second portion of airflow may have the same or differing volumetric flow rates.

During operation, a crop (e.g., corn) may be separated into grain and MOG by concave 134. The grain and MOG may pass through separation grate 136 and travel to rotor pan 138. As the grain and MOG falls toward rotor pan 138 the grain and MOG may be stratified by air (i.e., the first portion of airflow as represented by arrows 210). As the grain and MOG are separated by the first portion of airflow, the second portion of airflow may blow the MOG below and around rotor discharge 142.

The stratification may be caused by density differences between the grain and MOG. For example, corn kernels may have a higher density the stalk or cob. As the air passes toward rotor pan 138, the denser kernels may fall through the updraft at a faster rate than the stalk or cob. In other words, the first portion of airflow may retard a velocity of material other than grain to a greater extent that the velocity of the grain. Suspending the MOG in the airflow may allow the second portion of airflow to assist in moving the MOG toward the rear of combine 100 for discarding via rotor discharge 142.

The fan may be configured to cause the first portion of airflow and the second portion of airflow to pulsate. For example, the fan may be configured to cause the first portion of airflow and the second portion of airflow to pulsate asymmetrically. For instance, the fan may cause a sudden increase in the first portion of airflow's flow rate followed by a sudden increase in the second portion of airflow's flow rate. In other words, the fan may be configured to cause alternating pulses of airflow. The fan may also be configured to adjust a flow rate of the airflow.

In addition, the fan may be configured to cause the first portion of airflow and the second portion of airflow to pulsate symmetrically. For example, the fan may be configured to cause the first portion of airflow and the second portion of airflow to pulsate at approximately the same time. In addition, the first portion of airflow and the second portion of airflow may be uniform.

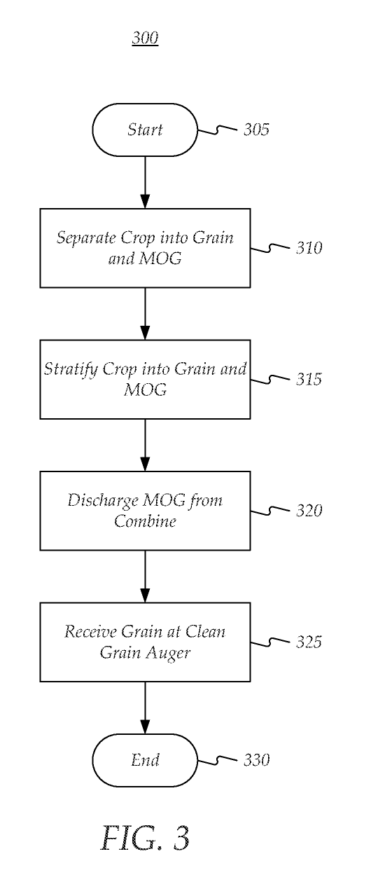

FIG. 3 shows a flowchart for a method 300 for separating grain from MOG. Method 300 may begin at stage 305 and proceed to stage 310 where a crop (e.g., corn) may be separated, via a rotor in threshing section 128, into grain and MOG. From stage 310 where the crop is separated into grain and MOG, method 400 may proceed to stage 315 where the grain and MOG may be stratified.

As described above, stratification of the grain and MOG may be accomplished by blowing the first portion of air opposite a direction of travel of the grain and the MOG. For instance, the grain and MOG may be traveling in a downward direction and the air may be traveling in an upward direction.

From stage 315 where the grain and MOG are stratified, method 300 may proceed to stage 320 where the MOG may be discharged from combine 100. The MOG may be discharged from combine 100 by blowing the second portion of air perpendicular to the first portion of air (i.e., toward rotor discharge 142. From stage 320 where the MOG is discharged from combine 100, method 300 may proceed to stage 325 where the grain is received at clean grain auger 148. Method 400 may then terminal at ending block 330.

An embodiment may comprise an apparatus. The apparatus may comprise a rotor pan, a sieve, a fan, and a duct having a wall. The rotor pan may be arranged below a rotor and may have an underside. The sieve may be arranged below the rotor pan. The fan may be arranged to blow air into an inlet. The wall may define a passage in fluid communication with the inlet, a first exhaust and a second exhaust. The first exhaust may be arranged to direct a first portion of airflow toward the underside of the rotor pan. The second exhaust may be arranged to direct a second portion of airflow substantially parallel to the rotor pan, both above and/or below the rotor pan.

Another embodiment may comprise an apparatus. The apparatus may comprise a combine having a rotor pan, a sieve, a fan, and a duct having a wall. The rotor pan may be arranged below a rotor and may have an underside. The sieve may be arranged below the rotor pan. The fan may be arranged to blow air into an inlet. The wall may define a passage in fluid communication with the inlet, a first exhaust and a second exhaust. The first exhaust may be arranged to direct a first portion of airflow towards the underside of the rotor pan. The second exhaust may be arranged to direct a second portion of airflow substantially parallel to the rotor pan.

Yet another embodiment may comprise a method. The method may comprise: separating, within a rotor, a crop into grain and material other than grain (MOG); stratifying the grain and MOG as the grain and MOG travel from the rotor to a sieve; and discharging the MOG from a combine.

Both the foregoing general description and the following detailed description are examples and explanatory only, and should not be considered to restrict the invention's scope, as described and claimed. Further, features and/or variations may be provided in addition to those set forth herein. For example, embodiments may be directed to various feature combinations and sub-combinations described herein.

All rights, including copyrights, in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example embodiments.

1. Cleaning apparatus for a combine harvester having a threshing mechanism with a rotor and a plurality of concaves for threshing grain and a rotor discharge for discharging material other than grain from the combine harvester, the cleaning apparatus for removing chaff from the threshed grain, the cleaning apparatus comprising:
a rotor pan arranged below said rotor and concaves and having an underside;
a sieve arranged below the rotor pan;
a fan assembly arranged to blow air, said fan assembly comprising a housing wall defining a first exhaust and a second exhaust, wherein the first exhaust is arranged at a first elevation and the second exhaust is arranged at a second elevation, the first elevation being lower than the second elevation, the first exhaust arranged to direct a first portion of airflow on the sieve where the first portion of airflow is then substantially directed upward toward the underside of the rotor pan, the second exhaust being located above the rotor an and below the concaves and arranged to direct a second portion of airflow between a top of the rotor pan and an underside of the concaves toward the rotor discharge.

2-6. (canceled)

7. The apparatus of claim 1, wherein the first portion of airflow is configured to retard a velocity of material other than grain.

8-16. (canceled)

17. A method for removing chaff from threshed grain in a combine harvester having a threshing mechanism with a rotor and a plurality of concaves such that threshed grain falls on a rotor pan and material other than grain (MOG) is discharged from the combine harvester through a rotor discharge, the method comprising:
separating a crop into grain and MOG with said rotor and plurality of concaves;
stratifying the grain and MOG as the grain and MOG travel from the rotor to a sieve by blowing a first portion of airflow from a first exhaust of a fan assembly through the sieve and toward an underside of the rotor pan; and
discharging the MOG from a combine by blowing a second portion of airflow from a second exhaust of said fan assembly, wherein the second exhaust is located above the rotor an and below the concaves such that said second portion of airflow is directed between a top of the rotor an and an underside of the concaves toward the rotor discharge.

18. The method of claim 17, wherein stratifying the grain and the MOG comprises blowing said first portion of flow opposite a direction of travel the grain and the MOG travel.

19. The method of claim 18, wherein discharging the MOG from the combine comprises blowing said second portion of air perpendicular to the first portion of airflow.

20. The method of claim 19, wherein blowing a first portion of air opposite a direction of travel the grain and the MOG travel and blowing the second portion of air perpendicular to the first portion of air comprise utilizing a single fan to generate the first portion of air and the second portion of air.
